(19) United States
(12) Patent Application Publication
(10) Pub. No.: US 2017/0212712 A1
(43) Pub. Date: Jul. 27, 2017

(54) DYNAMIC COLLECTION, CONTROL AND CONVEYANCE OF 3-DIMENSIONAL DATA IN A NETWORK

(71) Applicants: Braxton CARTER, La Jolla, CA (US); Justim E CARLSON, Houston,, TX (US)

(72) Inventors: Braxton Carter, La Jolla, CA (US); Justin E Carlson, Houston, TX (US)

(21) Appl. No.: 15/325,027

(22) PCT Filed: Jul. 8, 2015
(86) PCT No.: PCT/US15/39580

§ 371 Date: Jan. 9, 2017

Related U.S. Application Data
(60) Provisional application No. 62/022,174, filed on Jul. 8, 2014.
(60) Provisional application No. 62/022,588, filed on Jul. 9, 2014.
(60) Provisional application No. 62/022,597, filed on Jul. 9, 2014.

(51) Int. Cl. G06F 3/12; G06Q 10/10; G06F 17/30

(52) U.S. Cl. CPC G06F 3/1206; G06F 17/30076; G06Q 10/10; G06F 3/1285; G06F 3/126

(57) ABSTRACT

Systems, methods, devices and computer program products enable capture, processing, storage, communication and transactions related to 3-dimensional (3D) data. A system for managing 3D data includes a cloud comprising data storage devices and processors coupled to a network to receive, store and transmit data including 3D data. The system includes an entry point coupled to a 3D data generation device that receives data produced from 3D scans of an object and converts the data into a customized format for ingestion by the network. The customized format includes data and header sections, and a field for activating an algorithm including a data conversion algorithm to produce 3D data in a first data format that is different from the customized format. The system also includes an exit point that receives and produces the 3D data in the first data format that is compatible for consumption by a device at the exit point.

### RELATED APPLICATIONS

This patent application claims the benefit of priority to the provisional application with Ser. No. 62/022,174, titled “Data format for efficient transfer of data,” filed on Jul. 8, 2014, the provisional application with Ser. No. 62/022,588, titled “Systems and methods for dynamic collection, control, and conveyance of data,” filed on Jul. 9, 2014, and the provisional application with Ser. No. 62/022,597, titled “Apparatus for capturing object data,” filed on Jul. 9, 2014. The entire contents of the above mentioned applications are incorporated herein by reference in their entirety for all purposes.

### FIELD OF INVENTION

The present application relates to generation, storage, communication and consumption of three dimensional data.

### BACKGROUND

Scanning and printing technology, particularly in 3D, has matured significantly over recent years. Spurred by an endless spectrum of potential applications, the technology has quickly grown out of the empirical and industrial niche, and is clearly poised to capture the mass consumer market and become the new norm.

### SUMMARY

The disclosed embodiments relate to systems, methods, devices and computer program products that enable capture, processing, storage, communication and consumption of 3-dimensional data in a networked environment.

One aspect of the disclosed technology relates to a system for managing 3-dimensional data that includes a cloud comprising a plurality of data storage devices and one or more processors coupled to a network to receive, store and transmit data including 3-dimensional data. The system also includes an entry point coupled to the network, the entry point further coupled to a 3-dimensional data generation device, the 3-dimensional data generation device to receive data produced from 3-dimensional scans of an object and to convert the data produced from 3-dimensional scans into a customized format for ingestion by the network. The customized format includes a data section, a header section, and a field for activating an algorithm including a data conversion algorithm to operate on at least a portion of the data section and to produce 3-dimensional data in a first data format that is different from the customized format. The system further includes at least one exit point coupled to the network. The at least one exit point to receive the 3-dimensional data routed by the network in the customized format, and to produce the 3-dimensional data in at least the first data format that is compatible for consumption by a device at the least one exit point.

In one exemplary implementation, the one or more processors process at least a portion of the header section to route the 3-dimensional data in the customized format to the at least one exit point. In particular, the at least the portion of data can identify a path of data to be traversed by the 3-dimensional data before reaching an identified entity at the at least one exit point. In another exemplary implementation, the cloud is coupled to a 3D community comprising a plurality of 3-dimensional vendors, product manufacturers, sellers, buyers, brokers or professional service providers. One or more entities within the 3D community can operate as a broker of 3-dimensional user data to receive the 3-dimensional data and to authorize transfer of the received 3-dimensional data to a recipient within the cloud community. In some implementations, the network is coupled to a second network associated with the one or more entities to allow reception of the 3-dimensional data from the second network into the network.

In one exemplary implementation, the entry point enables a user to upload 3-dimensional data onto the cloud and to provide an entitlement associated with the uploaded 3-dimensional data. The entitlement can include an authorization for a particular entity of the 3D community to use the uploaded 3-dimensional data for a particular purpose and for a particular period of time. In one exemplary implementation, the entitlement specifies one of a sale or a lease of the 3-dimensional data. In another exemplary implementation, the entitlement authorizes data mining operations for research, analysis or collaboration purposes.

In one exemplary implementation, the above noted system further includes an additional node configured to allow the user to log in as a member of the 3D community and to specify the entitlement subsequent to uploading of the 3-dimensional data. In yet another exemplary implementation, the 3D Community is operated by a 3D entity that enables aggregation and distribution of 3-dimensional data corresponding to anatomical body parts for facilitating design or manufacture of prosthetics.

In another exemplary implementation, the above noted system further includes an additional entity coupled to both the entry point and to the exit point, the additional entity to (a) receive at least one portion of the 3-dimensional data in the customized format, (b) access the at least one portion of the 3-dimensional data in a format that is compatible with a device at the additional entity, and (c) instruct the network to provide the at least one portion, or segments thereof, in the customized format to the at least one exit point. In one exemplary implementation, the device at the additional entity includes a processor comprising electronic circuitry to execute the algorithm to convert data section of the at least one portion of the 3-dimensional data into the compatible format. In still another exemplary embodiment the processor further manipulates the at least one portion of the 3-dimensional data to generate a modified 3-dimensional data file. In some implementations, the additional entity is controlled by a third party entity different from entities that control the entry point and the exit point.

In one exemplary implementation, at least some components of the entry point reside within the network, and the conversion of the data produced from 3-dimensional scans into the customized format is carried out by components of the entry point that reside within the network. In another exemplary implementation, at least some components of the entry point reside outside of the network, and the conversion of the data produced from 3-dimensional scans into the customized format is carried out by components of the entry point that reside outside of the network. In yet another exemplary implementation of the above system, the customized data format further includes an asset identification that uniquely identifies the 3-dimensional data.

In one exemplary implementation of the above system, the at least one exit point is coupled to one or more of the following: a printer capable of rendering a physical 3-dimensional object, a device that is capable of rendering a hologram image, a device that is capable of rendering a 2-dimensional image, one or more 3-dimensional printers that are part of a printer farm, a device for 3-dimensional rendering of 3-dimensional data that is part of a person's medical record, or a bio-printing device.

Another aspect of the disclosed technology relates to a computer program product, embodied on one or more non-transitory computer readable medium, that includes program code for operating a cloud comprising a plurality of data storage devices and one or more processors coupled to a network to receive data including 3-dimensional data from a first entity that is part of a 3D community and is coupled to the network, to process or to store the received 3-dimensional data, and to transmit the 3-dimensional data or the processed 3-dimensional data to a second entity that is part of the 3-dimensional community. The computer program product further includes program code for operating an entry point coupled to the network, the entry point further coupled to a 3-dimensional data generation device, the program code to receive data produced from 3-dimensional scans of an object by the 3-dimensional data generation device and to convert the data produced from 3-dimensional scans into a customized format for ingestion by the network, the customized format including a data section, a header section, and a field for activating an algorithm including a data conversion algorithm to operate on at least a portion of the data section and to produce 3-dimensional data in a first data format that is different from the customized format. The computer program product also includes program code for operating at least one exit point coupled to the network, the program code to receive the 3-dimensional data routed by the network in the customized format, and to produce the 3-dimensional data in at least the first data format that is compatible for consumption by a device at the least one exit point.

In one exemplary implementation, the one or more processors process at least a portion of the header section to route the 3-dimensional data in the customized format to the at least one exit point. In one exemplary implementation, the at least the portion of data identifies a path of data to be traversed by the 3-dimensional data before reaching an identified entity at the at least one exit point. In another exemplary implementation, the 3D community comprises a plurality of 3-dimensional vendors, product manufacturers, sellers, buyers, brokers or professional service providers. In still another exemplary implementation, one or more entities within the 3D community operate as a broker of 3-dimensional user data to receive the 3-dimensional data and authorize transfer of the received 3-dimensional data to a recipient within the cloud community. For example, the network can be coupled to a second network associated with the one or more entities to allow reception of the 3-dimensional data from the second network into the network.

In another exemplary implementation, the computer program product includes program code for enabling a user to upload 3-dimensional data onto the cloud and to provide an entitlement associated with the uploaded 3-dimensional data. For example, the entitlement includes an authorization for a particular entity of the 3D community to use the uploaded 3-dimensional data for a particular purpose and for a particular period of time. In one exemplary embodiment, the entitlement specifies one of a sale or a lease of the 3-dimensional data. In another exemplary embodiment, the entitlement authorizes data mining operations for research, analysis or collaboration purposes.

In one exemplary implementation, the computer program product further includes program code for configuring an additional node to allow the user to log in as a member of the 3D community and to specify the entitlement subsequent to uploading of the 3-dimensional data. In yet another exemplary implementation, the 3D Community is operated by a 3D entity that enables aggregation and distribution of 3-dimensional data corresponding to anatomical body parts for facilitating design or manufacture of prosthetics. In still another exemplary implementation, the computer program product further includes program code for configuring a an additional entity coupled to both the entry point and to the exit point to: (a) receive at least one portion of the 3-dimensional data in the customized format, (b) access the at least one portion of the 3-dimensional data in a format that is compatible with a device at the additional entity, and (c) instruct the network to provide the at least one portion, or segments thereof, in the customized format to the at least one exit point.

In one exemplary implementation, the device at the additional entity includes a processor comprising electronic circuitry to execute the algorithm to convert data section of the at least one portion of the 3-dimensional data into the compatible format. In yet another exemplary implementation, the computer program product further includes program code to manipulate the at least one portion of the 3-dimensional data to generate a modified 3-dimensional data file. In some implementations, the additional entity is controlled by a third party entity different from entities that control the entry point and the exit point. In some exemplary implementations, at least some components of the entry point reside within the network, and the conversion of the data produced from 3-dimensional scans into the customized format is carried out by components of the entry point that reside within the network. In yet another exemplary implementation, at least some components of the entry point reside outside of the network, and the conversion of the data produced from 3-dimensional scans into the customized format is carried out by components of the entry point that reside outside of the network. In still another exemplary embodiment, the customized data format further includes an asset identification that uniquely identifies the 3-dimensional data.

Another aspect of the disclosed technology relates to a method for managing 3-dimensional data that includes receiving at an entry point data including data representing 3-dimensional scans of an object produced by a 3-dimensional data generation device, the entry point coupled to a network, and converting the data representing the 3-dimensional scans into a customized format for ingestion by the network. The customized format includes a data section, a header section, and a field for activating an algorithm including a data conversion algorithm to operate on at least a portion of the data section and to produce 3-dimensional data in a first data format that is different from the customized format. The above noted method further includes transmitting the 3-dimensional data in the customized format from the entry point to a cloud coupled to the network. The cloud comprises a plurality data storage devices and one or more processors implemented using electronic circuits and configured to store, perform additional processing or transmit the 3-dimensional data in the customized format to another entity of a 3D community. The above method also includes using the 3-dimensional data in the customized format to generate a 3-dimensional data in a first data format that is compatible for consumption by a device at least one exit point, and routing the 3-dimensional data in the first data format to the at least one exit point coupled to the network.

In one exemplary implementation, the above method also includes processing by the one or more processors at least a portion of the header section to route the 3-dimensional data in the customized format to the at least one exit point. In another exemplary implementation, at least the portion of data identifies a path of data to be traversed by the 3-dimensional data before reaching an identified entity at the at least one exit point. In another exemplary implementation, the 3D community comprises a plurality of 3-dimensional vendors, product manufacturers, sellers, buyers, brokers or professional service providers. In still another exemplary implementation of the above method, one or more entities within the 3D community operate as a broker of 3-dimensional user data, where the method further includes allowing the 3-dimensional data to be provided to the broker that is authorized to transfer the 3-dimensional data to a recipient within the cloud community.

In another exemplary implementation, where the network is coupled to a second network associated with the one or more entities, the above method further comprises allowing reception of the 3-dimensional data from the second network into the network. In one exemplary implementation, the above method further includes uploading the 3-dimensional data onto the cloud and providing an entitlement associated with the uploaded 3-dimensional data, where the entitlement includes an authorization for a particular entity of the 3D community to use the uploaded 3-dimensional data for a particular purpose and for a particular period of time. In some implementations, the entitlement specifies one of a sale or a lease of the 3-dimensional data. The entitlement, in some implementations of the above method, can authorize data mining operations for research, analysis or collaboration purposes.

In one exemplary implementation, the above noted method further includes allowing a user to log in as a member of the 3D community using an additional node and specifying the entitlement subsequent to uploading of the 3-dimensional data. In yet another implementation of the above noted method, the 3D Community is operated by a 3D entity that enables aggregation and distribution of 3-dimensional data corresponding to anatomical body parts for facilitating design or manufacture of prosthetics. In some exemplary implementations, the method includes (a) receiving at least one portion of the 3-dimensional data in the customized format at an additional entity coupled to both the entry point and to the exit point, (b) accessing the at least one portion of the 3-dimensional data in a format that is compatible with a device at the additional entity, and (c) instructing the network to provide the at least one portion, or segments thereof, in the customized format to the at least one exit point.

Another exemplary implementation of the above method includes using a processor comprising electronic circuitry at the additional entity to execute the algorithm to convert data section of the at least one portion of the 3-dimensional data into the compatible format. Such an exemplary implementation can further include manipulating the at least one portion of the 3-dimensional data to generate a modified 3-dimensional data file. In some exemplary implementations, the additional entity is controlled by a third party entity different from entities that control the entry point and the exit point.

In one exemplary implementation of the above method, at least some components of the entry point reside within the network, and the conversion of the data produced from 3-dimensional scans into the customized format is carried out by components of the entry point that reside within the network. In some exemplary implementations, at least some components of the entry point reside outside of the network, and the conversion of the data produced from 3-dimensional scans into the customized format is carried out by components of the entry point that reside outside of the network.

Another aspect of the disclosed technology relates to a device for producing 3-dimensional data that includes a processor comprising electronic circuitry, and a memory comprising processor executable code such that, the processor executable code when executed by the processor, causes the device to receive data produced from 3-dimensional scans of an object, and convert the data produced from 3-dimensional scans into a customized format. The customized format includes a header section, a data section, and a field for activating an algorithm that includes a data conversion algorithm for conversion of the data section into at least a first format that is different from the customized format.

In one exemplary implementation, the header section includes information identifying a path of data in a network, where the path of data identifies at least one exit point coupled to the network. In some exemplary implementations, the header section includes identifying information associated with one or both of an owner of the 3-dimensional data or an entity that is designated to receive the 3-dimensional data. In another exemplary implementation, the header section includes one or more of: a name, a social security number (SSN), an employer identification number (EIN), an entitlement, a country name, a bar code value, a destination preferred CAD file format, a (STereoLitography) (STL) flag, or resolution information corresponding to the data section. In still another exemplary implementation, the header section includes information regarding a number of frames and a size of each frame associated with at least a portion of the data section. In still another exemplary implementation, the data section includes one or both of a low resolution data or a high resolution data. In a particular implementation, the low resolution data is a low resolution version of the high resolution data with a reduced number of vertices for mesh features or a reduced number of points for point cloud features.

In one exemplary implementation, the data section includes data with a particular resolution that is customized based on the entry point or exit point requirements or specifications. In still another exemplary implementation, the customized format is associated with a cryptographic token that ensures secure storage, transmission and access of the 3-dimensional data. In yet another exemplary implementation, the customized format enables selective access to a particular portion of the data section by particular recipients at the at least one exit point. In another exemplary implementation, the header section includes an entitlement that entitles a particular entity of a 3D community to use the uploaded 3-dimensional data for a particular purpose and for a particular period of time.

In one exemplary implementation, the 3D community comprises a plurality of 3-dimensional vendors, product manufacturers, sellers, buyers, brokers or professional service providers. In another exemplary implementation, the data in the customized format is encrypted according to an encryption algorithm having a data encryption key of at least 128 bits. In still another exemplary implementation, at least the data section of the customized format is compressed according to a data compression algorithm. The data that is in the customized format is stored on a hardware memory device.

In one exemplary implementation, the above noted device that is responsible to producing the 3-dimensional data is part of an entry point to a 3D community. Such a 3D community comprises a plurality of 3-dimensional vendors, product manufacturers, sellers, buyers, brokers or professional service providers, and the device is configured to receive 3-dimensional data from a 3-dimensional data generation device, and to selectively convert a portion of the data provided by the 3-dimensional data generation device into the customized format for ingestion by a network and delivery by the network to a particular recipient of the 3D community at the at least one exit point of the network.

In one exemplary implementation, the data conversion algorithm operates on at least a portion of the data section to produce 3-dimensional data in the first data format without using a computer aided design (CAD) software or a viewer. In another exemplary implementation, the data conversion algorithm operates on at least a portion of the data section to produce 3-dimensional data in the first data format. In still another exemplary implementation, the customized format further includes an asset identification that uniquely identifies the 3-dimensional data. In yet another exemplary implementation, the customized format includes a section that includes the data conversion algorithm.

Another aspect of the disclosed technology relates to a method for producing a customized 3-dimensional data that includes receiving data produced from 3-dimensional scans of an object and converting the data produced from 3-dimensional scans into a customized format. The customized format includes a header section, a data section, and a field for activating an algorithm that includes a data conversion algorithm for conversion of the data section into at least a first format that is different from the customized format. The customized format allows reception, storage and transmission of the 3-dimensional data in the customized format throughout a network that can be selectively accessed by a plurality of devices of a 3D community at at least one exit point coupled to the network.

In one exemplary implementation, the header section includes information identifying a path of data in a network, where the path of data is used to identify the at least one exit point coupled to the network. In one exemplary implementation of the above method, the header section includes identifying information associated with one or both of an owner of the 3-dimensional data or an entity that is designated to receive the 3-dimensional data. The header section can includes one or more of: a name, a social security number (SSN), an employer identification number (EIN), an entitlement, a country name, a bar code value, a destination preferred CAD file format, a (STereoLitography) (STL) flag, or resolution information corresponding to the data section.

In another exemplary implementation of the above noted method, the header section includes information regarding a number of frames and a size of each frame associated with at least a portion of the data section. In one exemplary implementation, the above method further comprises producing a low resolution data from the 3-dimensional scans of the object, and placing one or both of a low resolution data or a high resolution data in the data section of the customized format. In one exemplary implementation, the low resolution data is a low resolution version of the high resolution data with a reduced number of vertices for mesh features or a reduced number of points for point cloud features.

In one exemplary implementation, the above noted method further includes producing data of a particular resolution based on the at least one exit point's requirements or specifications, and incorporating the data having the particular resolution as part of the data section of the customized format. In another exemplary implementation, the customized format is associated with a cryptographic token that ensures secure storage, transmission and access of the 3-dimensional data. In still another exemplary implementation, the customized format allows selective access to a particular portion of the data section by particular recipients at the at the least one exit point. In yet another exemplary implementation, the header section includes an entitlement that entitles a particular entity of a 3D community to use the 3-dimensional data for a particular purpose and for a particular period of time.

In one exemplary implementation of the above method, the 3D community comprises a plurality of 3-dimensional vendors, product manufacturers, sellers, buyers, brokers or professional service providers. In another exemplary implementation, the above method further includes encrypting the data in the customized format according to an encryption algorithm having a data encryption key of at least 128 bits. In still another exemplary implementation, the above method further includes compressing at least the data section of the customized format according to a data compression algorithm. In yet another exemplary implementation, the method also includes storing the data that is in the customized format on a hardware memory device.

In another exemplary implementation, the data conversion algorithm operates on at least a portion of the data section to produce 3-dimensional data in the first data format without using a computer aided design (CAD) software or a viewer. In one exemplary implementation, the data conversion algorithm operates on at least a portion of the data section to produce 3-dimensional data in the first data format. In still another exemplary implementation of the above method, the customized format further includes an asset identification that uniquely identifies the 3-dimensional data. In another exemplary implementation, the customized format includes a section for including the data conversion algorithm.

Another aspect of the disclosed technology relates to a computer program product, embodied on one or more computer readable media, that includes program code for receiving data produced from 3-dimensional scans of an object, and program code for converting the data produced from 3-dimensional scans into a customized format. Such a customized format includes a header section, a data section, and a field for activating an algorithm that includes a data conversion algorithm for conversion of the data section into at least a first format that is different from the customized format. The customized format allows reception, storage and transmission of the 3-dimensional data in the customized format throughout a network that can be selectively accessed by a plurality of devices of a 3D community at least one exit point coupled to the network.

In one exemplary implementation of the computer program product, the header section includes information identifying a path of data in a network, where the path of data is used to identify the at least one exit point coupled to the network. In another implementation, the header section includes identifying information associated with one or both of an owner of the 3-dimensional data or an entity that is designated to receive the 3-dimensional data. In still another exemplary implementation, the header section includes one or more of: a name, a social security number (SSN), an employer identification number (EIN), an entitlement, a country name, a bar code value, a destination preferred CAD file format, a (STereoLitography) (STL) flag, or resolution information corresponding to the data section. In yet another implementation, the header section includes information regarding a number of frames and a size of each frame associated with at least a portion of the data section.

In another exemplary implementation, the computer program product further comprises program code for producing a low resolution data from the 3-dimensional scans of the object, and placing one or both of a low resolution data or a high resolution data in the data section of the customized format. In one exemplary implementation, the low resolution data is a low resolution version of the high resolution data with a reduced number of vertices for mesh features or a reduced number of points for point cloud features. In still another exemplary implementation, the computer program product includes program code for producing data of a particular resolution based on the at least one exit point's requirements or specifications, and incorporating the data having the particular resolution as part of the data section of the customized format.

In one exemplary implementation, the customized format is associated with a cryptographic token that ensures secure storage, transmission and access of the 3-dimensional data. In another exemplary implementation, the customized format allows selective access to a particular portion of the data section by particular recipients at the at the least one exit point. In still another exemplary implementation, the header section includes an entitlement that entitles a particular entity of a 3D community to use the 3-dimensional data for a particular purpose and for a particular period of time. In yet another exemplary implementation, the 3D community comprises a plurality of 3-dimensional vendors, product manufacturers, sellers, buyers, brokers or professional service providers.

In another exemplary implementation, the computer program product further comprises program code for encrypting the data in the customized format according to an encryption algorithm having a data encryption key of at least 128 bits. In one exemplary implementation, the computer program product further includes program code for compressing at least the data section of the customized format according to a data compression algorithm. In yet another exemplary implementation, the computer program product further includes program code for storing the data that is in the customized format on a hardware memory device.

In one exemplary implementation of the computer program product, the data conversion algorithm operates on at least a portion of the data section to produce 3-dimensional data in the first data format without using a computer aided design (CAD) software or a viewer. In another exemplary implementation, the data conversion algorithm operates on at least a portion of the data section to produce 3-dimensional data in the first data format. In still another exemplary implementation, the customized format further includes an asset identification that uniquely identifies the 3-dimensional data, and in another exemplary implementation, the customized format includes a section that includes the data conversion algorithm.

Another aspect of the disclosed technology relates to a device that includes a source of electromagnetic radiation to direct radiation to an object, an imaging device to receive at least a portion of radiation reflected from the object, and a processor coupled to the imaging device to receive data representative of a 3-dimensional image of the object and to process the received data to produce a customized 3-dimensional data format corresponding to the object. The customized format produced by the processor includes a header section, a data section, and a field for activating an algorithm that includes a data conversion algorithm for conversion of the data section into at least a first format that is different from the customized format. The above noted device also includes a communication component to allow access to a network.

In one exemplary implementation, a portion of the 3-dimensional data corresponds to an anatomical part. In another exemplary implementation, the device is part of an entry point that is coupled to the network, and includes a user interface to present a user agreement document to a user of the network and to receive a confirmation that the user has agreed to terms of the user agreement document. In one specific implementation, the user agreement document specifies a transfer in ownership of the 3-dimensional data. In one exemplary implementation, at least the source and the imaging device are part of a kiosk that generates data corresponding to scans of the object. In another exemplary implementation, the source of electromagnetic radiation includes one or more of the following for directing a radiation or illumination to the object: a blue light scanner, a laser, a light source, an X-ray source, or a radioactive source.

In another exemplary implementation, the imaging device includes one or more of the following to receive radiation from the object: a Geiger counter or a light-capturing device. In one exemplary implementation, the imaging device includes a single radiation-capturing device positioned at a fixed point and a series of reflective surfaces to allow collection of light from different surfaces of the object at the single radiation-capturing device. In yet another exemplary implementation, the series of reflective surfaces include one or more of a mirror or a prism. In still another exemplary implementation, the imaging device includes a rotation or translation system that is capable of rotating or moving the object to allow a 360-degree view of the object. In still another implementation, the imaging device includes a rotation or translation system that is capable of rotating or moving an optical device around the object positioned at a fixed point.

In one exemplary implementation, the above noted device is part of an entry point to the network and is configured to allow a vendor to present a product or service to the network and/or an entity that is coupled to the network. In still another exemplary implementation, the device is part of an entry point to the network that allows routing of the 3-dimensional data in the customized format to at least one exit point that is coupled to one or more of the following: a printer capable of rendering a physical 3-dimensional object, a device that is capable of rendering a hologram image, a device that is capable of rendering a 2-dimensional image, or one or more 3-dimensional printers that are part of a printer farm. In still another exemplary implementation, the 3-dimensional data is routed in the customized format to a particular device at the exit point based on particular materials that are available to the particular device. In yet another exemplary implementation, the particular material is one or more a plastic material or metallic material. In one exemplary implementation, the customized format includes permissions that allows selection of a particular device at the at least one exit point.

Another aspect of the disclosed technology relates to a method that includes causing a source of electromagnetic radiation to direct radiation to an object, receiving at an imaging device at least a portion of radiation reflected from the object, and using a processor implemented using electronic circuits and coupled to the imaging device to receive data representative of a 3-dimensional image of the object, and to process the received data to produce a customized 3-dimensional data format corresponding to the object. The customized format includes a header section, a data section, and a field for activating an algorithm that includes a data conversion algorithm for conversion of the data section into at least a first format that is different from the customized format, where the customized format allows reception, storage and transmission of the 3-dimensional data in the customized format throughout a network that can be selectively accessed by a plurality of devices of a 3D community at at least one exit point coupled to the network.

In one exemplary implementation of the above method, a portion of the 3-dimensional data corresponds to an anatomical part. In another exemplary implementation, the above method further includes presenting a user agreement document on a user interface and receiving a confirmation that the user has agreed to terms of the user agreement document. In one exemplary implementation, the user agreement document specifies a transfer in ownership of the 3-dimensional data. In still another exemplary implementation, at least the source and the imaging device are part of a kiosk that generates data corresponding to scans of the object. In another exemplary implementation, the source of electromagnetic radiation includes one or more of the following for directing a radiation or illumination to the object: a blue light scanner, a laser, a light source, an X-ray source, or a radioactive source. In still another exemplary embodiment, the above noted method includes using one or more of the following to receive radiation from the object: a Geiger counter, or a light-capturing method.

In one exemplary implementation, the above noted method includes using a single radiation-capturing device positioned at a fixed point and a series of reflective surfaces to collect light from different surfaces of the object at the single radiation-capturing method. In another specific implementation, the series of reflective surfaces include one or more of a mirror or a prism. In another exemplary implementation, the above method includes using a rotation or translation system that is capable of rotating or moving the object to allow a 360-degree view of the object. In yet another exemplary implementation, the method includes using a rotation or translation system that is capable of rotating or moving an optical device around the object positioned at a fixed point as part of the imaging device.

In one exemplary implementation, the above method further includes routing of the 3-dimensional data in the customized format to the at least one exit point that is coupled to one or more of the following: a printer capable of rendering a physical 3-dimensional object, a device that is capable of rendering a hologram image, a device that is capable of rendering a 2-dimensional image, or one or more 3-dimensional printers that are part of a printer farm. In another exemplary implementation, the above method includes routing the 3-dimensional data in the customized format to a particular device at the exit point based on particular materials that are available to the particular device. In one exemplary implementation, the particular material is one or more a plastic material or metallic material. In another exemplary implementation, the customized format includes permissions that allows selection of a particular device at the at least one exit point.

Another aspect of the disclosed technology relates to a computer program product, embodied on one or more no-transitory computer storage media, that includes program code for causing a source of electromagnetic radiation to direct radiation to an object, program code for receiving at an imaging device at least a portion of radiation reflected from the object, and program code for using a processor implemented using electronic circuits and coupled to the imaging device to receive data representative of a 3-dimensional image of the object, and to process the received data to produce a customized 3-dimensional data format corresponding to the object. The customized format includes a header section, a data section, and a field for activating an algorithm that includes a data conversion algorithm for conversion of the data section into at least a first format that is different from the customized format, where the customized format allows reception, storage and transmission of the 3-dimensional data in the customized format throughout a network that can be selectively accessed by a plurality of devices of a 3D community at at least one exit point coupled to the network.

In one exemplary implementation, the a portion of the 3-dimensional data corresponds to an anatomical part. In another exemplary implementation, the computer program product further comprises program code for presenting a user agreement document on a user interface and receiving a confirmation that the user has agreed to terms of the user agreement document. In another exemplary implementation, the user agreement document specifies a transfer in ownership of the 3-dimensional data. In yet another exemplary implementation, at least the source and the imaging device are part of a kiosk that generates data corresponding to scans of the object. In still another exemplary implementation, the source of electromagnetic radiation includes one or more of the following for directing a radiation or illumination to the object: a blue light scanner, a laser, a light source, an X-ray source, or a radioactive source. In one exemplary implementation, the computer program product includes program code for receiving radiation from the object using one or more of: a Geiger counter, or a light-capturing device. In yet another exemplary implementation, the imaging device includes a single radiation-capturing device positioned at a fixed point and a series of reflective surfaces to collect of light from different surfaces of the object at the single radiation-capturing device. In one exemplary implementation, the series of reflective surfaces include one or more of a mirror or a prism.

In another exemplary implementation, the imaging device includes a rotation or translation system that is capable of rotating or moving the object to allow a 360-degree view of the object. In yet another exemplary implementation, the imaging device includes a rotation or translation system that is capable of rotating or moving an optical device around the object positioned at a fixed point as part of the imaging device. In one exemplary implementation, the computer program product further comprises program code for routing of the 3-dimensional data in the customized format to the at least one exit point that is coupled to one or more of the following: a printer capable of rendering a physical 3-dimensional object, a device that is capable of rendering a hologram image, a device that is capable of rendering a 2-dimensional image, or one or more 3-dimensional printers that are part of a printer farm.

In still another exemplary implementation, the computer program product includes program code for routing the 3-dimensional data in the customized format to a particular device at the exit point based on particular materials that are available to the particular computer program product. In one exemplary implementation, the particular material is one or more a plastic material or metallic material. In another exemplary implementation, the customized format includes permissions that allows selection of a particular method at the at least one exit point.

### BRIEF DESCRIPTION OF THE DRAWINGS

FIG. 1. illustrates a system for dynamically collecting, managing, and distributing data in accordance with an exemplary embodiment.

FIG. 2(a) is an illustration of data that is encapsulated in a specified file format in accordance with an exemplary embodiment.

FIG. 2(b) illustrates certain operations that can be carried out to produce and navigate data in the specified file format in accordance with an exemplary embodiment.

FIG. 3 is an exemplary diagram of various operations that can be carried out on by different entities or components of the cloud community to facilitate management, processing and traversal of 3-dimensional data within the cloud community.

FIG. 4 illustrates an exemplary Data Path using 3 nodes of the 3-dimensional cloud community.

FIG. 5 illustrates a set of operations 500 that can be carried out to dynamically collect, manage, and distribute data.

FIG. 6 is a block diagram illustrating an embodiment of a wired or wireless System that may be used in connection with various embodiments.

FIG. 7 illustrates a set of exemplary operations for managing 3-dimensional data in accordance with the disclosed technology.

FIG. 8 illustrates a set of exemplary operations for producing a customized 3-dimensional data for ingestion by the 3D community in accordance with the disclosed technology.

FIG. 9 illustrates a set of exemplary operations for producing a customized 3-dimensional data by an entry point of a 3D community in accordance with the disclosed technology.

### DETAILED DESCRIPTION OF CERTAIN EMBODIMENTS

The democratization of scanning and printing technology also gives rise to a massive motley of data. In the present digital ecosystem, conventional data types (e.g., .doc, .jpeg, .mpeg, IGES, STEP) are generally able to convey information seamlessly between different users over multiple platforms (e.g., iOS, Android, Mac, Windows, Unix). But there is so far no uniform scheme in place for handling data, particularly in multi-party transactions involving such data. For example, an individual, let's call him Sam, can take a scan of his foot, which generates one type of data file. Sam's orthopedist, meanwhile, has an electronic health record that describes Sam's foot injury. Data including, but not limited to, the data file and electronic health records are required by a third party, such as Dr. Scholl's®, an insole manufacturer, in order to design and subsequently print an appropriate shoe insert for Sam. However, such data files and medical records cannot be readily shared amongst Sam, his orthopedist and the insole manufacturer due to lack of a uniform file format and the associated processing capabilities of the involved parties.

In another scenario, a third-party entity, such as a manufacturer or a research agency, can benefit from obtaining and otherwise aggregating data from more than one user like Sam. For instance, Dr. Scholls®, can benefit from aggregating data (e.g., 3D foot images) from Sam, Alice, and Bob, and analyze this larger data set in order to develop a better insole. Additionally, a user like Sam should also be able to submit design data to a third-party entity. However, with current technology, none of the parties can easily and securely transfer, package, receive, and ultimately exploit the data. Consequently, any potential marketplace for data would lack critical fluidity and efficiency.

The present inventors seek to create, through the technology disclosed herein, an ethical, logical, evolved, and more perfect marketplace where all contributing persons get their earned and negotiated share. The disclosed technology enables such a marketplace by creating an ecosystem that allows buyers, sellers, traders, manufacturers (e.g., equipment manufacturers, product manufacturers, etc.), professional service providers (e.g., legal, real estate, financial service and other service providers), vendors, users and other entities to come together and collectively benefit from, and participate in, a multitude of transactions and activities that relate to generation, modification, consumption, and/or dissemination of 3-dimensional data and related products and services. Entities in this a community can collaborate on 3-dimensional data to make and sell products, and to create new businesses and business opportunities. Such a community is sometimes referred to as the “3DC Community,” or the “3DCC,” or the “3D community” in this document.

A participant in the 3DC Community can gain access to at least some of the features and functionalities related to 3-dimensional products and services through an entry and/or an access point to a system that will be further described in this document. Such an entry point can, for example, include a kiosk that includes a 3-dimensional scanner that allows Sam to capture a 3-dimensional image of his foot. In this example, an exit point can be 3-dimensional printer that allows Sam's 3-dimensional data to be made into an actual and physical insole. As will be described in further detail below, the disclosed technology enables a number of additional operations and processes, other than the generation of such a 3-dimensional image and the production of the insole, to take place. These processes and operations not only facilitate the generation, storage, accessibility and movement of the 3-dimensional data and related products and services, but they also provide many features and benefit that are not realized or contemplated by the existing technology. The disclosed technology further enables business lead generation, collection and use of analytics, and transactional tasks that relate to 3-dimensional data, products and services. For example, the disclosed technology enables various data mining activities including collection, extraction, warehousing and analysis of the data to extract particular patterns, statistics or other information.

One of the aspects of the disclosed technology relates to a particular data transformation procedure and file format generation that allows the 3-dimensional data to be distributed to, or shared amongst, a wide array of entities in the 3DC Community. Further details of the file format will be described in further detail below. The disclosed system can further allow social media links to be incorporated into the 3DC community, can allow 3rd parties to provide services (e.g., a hospital that can review and revise the 3D data and subsequently transmit the data to a particular prostheses manufacturer), and other features and benefit that will be described in this document.

One aspect of the disclosed technology relates to a cloud-based platform or a cloud community that dynamically collects, manages, and distributes data. Such a Cloud community is an example of a 3DC Community. The cloud community is associated with multiple physical entry points. In one example of a physical entry point, a kiosk with a camera, a scanner (e.g., an HDI 120 Scanner from LMI Technologies), or a system of cameras or scanners capable of capturing data, is coupled to the cloud. The physical entry points associated with the cloud community can be configured to capture data in a specified format (e.g., .3DC file format). Additional details regarding this file format will be described in the sections that follow. A user can enter the cloud community by capturing data at or using one of the physical entry points, and then uploading the data to the cloud community. For instance, a user can capture data at the kiosk and the kiosk subsequently generates a .3DC file (e.g., XYZ.3DC) containing the data.

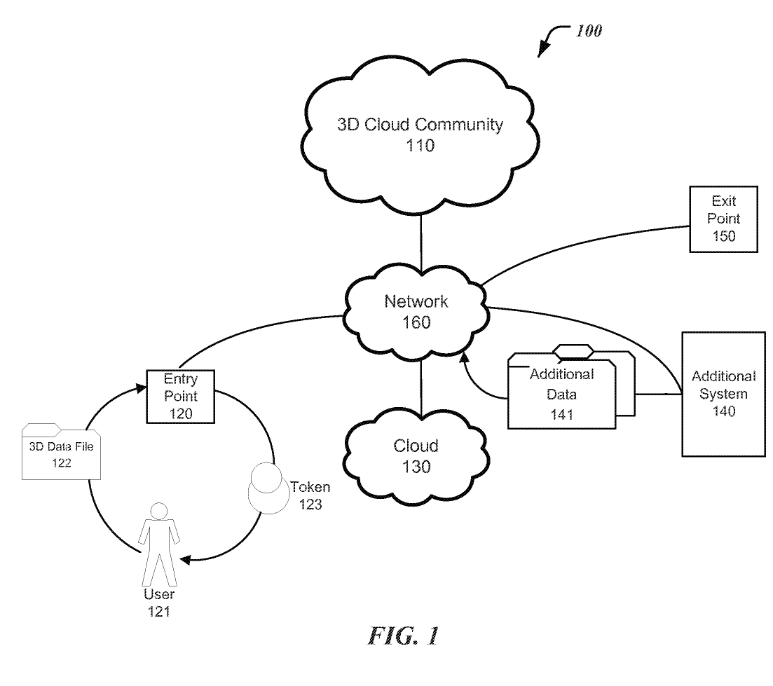

FIG. 1 illustrates a System 100 for dynamically collecting, managing, and distributing data in accordance with an exemplary embodiment. The System 100 is capable of dynamically collecting, managing, and distributing 3-dimensional data. The System 100 can also dynamically collect, manage, and distribute multiple other types of data such as MP3, JPEG, etc. The System 100 is configured in accordance with the systems and methods described herein. The System 100 comprises a Cloud Community 110, which communicates with multiple entities, including an Entry Point 120, a Cloud 130, an Additional System 140, and an Exit Point 150 via a Network 160. The Cloud 130 can include groups of remote servers that are networked to allow sharing of data-processing tasks, centralized data storage, and online access to computer services or resources.

According to some embodiments, the Entry Point 120 is a device or a system that is capable of providing or uploading data to the cloud 130. In some implementations, the Entry Point 120 includes the bare minimum software and/or hardware capabilities to allow ingestion of data to the cloud 130. In such implementations, the Entry Point 120 may still provide some of the necessary data processing operations, such as transforming the data, to facilitate storage and/or reception of data by the cloud 130 or other components of the system 100. In some implementations, the Entry Point 120 is coupled to various data capture and processing equipment (e.g., a multi-purpose kiosk equipped with a 3D scanning device). Such equipment may capture object data with or without illumination. For example, a data capture device can use a blue light scanner, a laser, or an X-ray (e.g., CAT scan, synchrotron, desktop synchrotron) that captures data in the form of electromagnetic radiation (e.g., light waves or X-rays). In other examples, the device can be a Geiger counter that collects data in the form of particles (e.g., radioactive decay, explosives, odors). The signals obtained from such devices are converted it to a analog and/or digital values that can be stored on a non-transitory computer readable media. In some implementations, a capture device at an Entry Point 120 can be accessible by remote users. For example, a user may use a remote control device to activate and initiate a 3D scanning device at the Entry Point 120.

In some implementations, the Entry Point 120 is a system that includes a single device capable of capturing object data (e.g., a blue light scanner, an X-ray, a laser), and a series of one or more reflective surfaces (e.g., mirrors, a disco ball). As such, the Entry Point 120 can capture panoramic, 360 degree image data using the single device placed at a fixed point and the series of reflective surfaces. In some implementations, the Entry Point 120 can include a rotation or translation system and an optical device that is capable of detecting an object with or without illumination. The rotation or translation system can, for example, rotate, spin, or otherwise translate the object to allow a 360 degree field of view that can be used to create 3-dimensional image data associated with the object using the optical system positioned at a fixed point. Alternately, or additionally, the Entry Point 120 can include a rotation system that is capable of turning an optical device around the object positioned at a fixed point.

The Entry Point 120 may further be able to capture data and generate a file in a specified format (e.g., .3DC format). Further details regarding the .3DC format will be described in later sections of this document. The User 121 uses the Entry Point 120 to capture data and to generate a corresponding Data File 122. As noted earlier, the disclosed techniques can generate the Data File 122 in a specified format such as .3DC file format.

The Data File 122 can be have an associated Token 123. The Token 123, which can include a virtual and/or a physical component, operates as a physical or virtual key to the Cloud Community 110. A user (such as the User 121) can enter the Cloud Community 110 by providing the Token 123 (e.g., uploading data to the cloud community) and leave the Cloud Community 110 by removing the Token 123 (e.g., permanently removing data from the cloud community). The physical entry points can be configured to dispense unique tokens to entrants of Cloud Community 110 for each file that is generated and encapsulated at the Entry Point 120. For example, each .3DC file corresponds to a unique token. The Token 123 can be a virtual token that uniquely identifies or encapsulates the Data File 122. Alternately or in addition, the Data File 122 can be loaded onto a physical or a hardware component (e.g., a USB drive), giving rise to a physical or a hardware token. The kiosk can, for example, load individual .3DC files onto respective USB drives.

The Cloud Community 110 can process and modify the uploaded data, which can include encrypting a data file in order to protect the Cloud Community 110 participants in the data market (e.g., source, innovators, developers, end users, etc.). Data encryption effectively addresses Standard for the Exchange of Product model data (STEP) trade secret and patent right issues in the data market. In one implementation, the Cloud Community 110 encrypts data files based on specified or tailored guidelines (e.g., HIPAA-compliant 128-bit encryption). Processing and modifying of the uploaded data can also include adding or incorporating additional data to a data file. The Cloud Community 110 can perform the processing and the modifications at the discretion or direction of individual users. For example, a user can request that additional data be added to or included in the user's .3DC file. FIG. 1 illustrates an exemplary Additional System 140 that is capable of providing Additional Data 141. At the discretion or direction of User 121, Cloud Community 110 adds, incorporates, or attaches Additional Data 141 to Data File 122.

The Cloud Community 110 is capable of transacting data with a diverse array of third-party cloud platforms. For example, the Additional System 140 in FIG. 1 can be an example system that is associated with a third-party entity. The Cloud Community 110 can transfer, deliver, or otherwise make available the uploaded data to any specified party. In one example, such a task is implemented by allowing the user to provide a unique token (either physical or virtual) and then assign one or more parties as recipients of the corresponding data file. The receiving parties or entities can then access the data file to, for example, view, manipulate, or otherwise interact with the data. The Cloud Community 110 can also maintain full ownership of data (e.g., the Data File 122) that has been uploaded by various users (e.g., User 121) to the Cloud Community 110.

In some embodiments, the Cloud Community 110 acts as a broker of user data such that the User 121 can request, direct, or authorize the transfer or release of the Data File 122 to the Cloud 130 (which can be a third-party cloud platform) by providing or referring to the Token 123.

The Cloud Community 110 also gives users, such as the User 121 of FIG. 1, control over their information feed. Users are able to opt in and opt out of receiving information from third-parties (e.g., other users, entities). For example, the User 121 can subscribe to receive information such as offers and promotions from an entity like Dr. Scholl's®. However, the User 121 can select not to receive data that the User 121 has not actively subscribed to. In contrast to the disclosed system, the existing communities, such as social networks, push data to the users without the users' consent. In some implementations, at the discretion or direction of the User 121, the Cloud Community 110 further allows the Additional System 140 to access, manipulate, and otherwise interact with the Data File 122.

The Cloud Community 110 is further associated with one or more Exit Points 150. The Exit Point 150 can be an appropriate device that is capable of rendering or realizing the Data File 122. The Data File 122 can be rendered in a single or multiple dimension(s) (e.g., 1D, 2D, 3D, 4D, etc.) and may include associated meta data, instructions, entitlements, and other features. One example of an Exit Point 150 is a printer capable of rendering tangible, physical, 3-dimensional objects based on a data file. For instance, such a printer can be part of a printer farm. The User 121 can direct the Cloud Community 110 to give access to or provide Data File 122 to the printing farm. Furthermore, the User 121 can select one or more of the available printers at the printing farm based on needs and/or criteria. For example, if the User 121 wants to render the Data File 122 in a particular material (e.g., plastic, metal), the User 121 can choose an appropriate printer at the printing farm based on the capabilities of the individual printers. Another example of an Exit Point 150 is a device that is capable of rendering a hologram image. The rendering at the Exit Point 150 can be done with or without additions and modifications (e.g., from Additional System 140). It should be noted that the Entry Point 120 and the Exit Point 150 are depicted as separate entities or nodes of the system, in some embodiments, the same system can operate as both an entry and an exit point.

One or more parties can exit the Cloud Community 110 when, for example, data transacted between the parties (e.g., captured, modified, and/or transferred) is rendered (e.g., printed, projected) at an Exit Point 150. The User 121 has the discretion or the authority to cause the Data File 122 to exit the Cloud Community 110 at the Exit Point 150. For instance, the User 121 can directly or indirectly (i.e., via the Cloud Community 110) instruct the Exit Point 150 to print the Data File 122. In some implementations, users like the User 121 access the Cloud Community 110 using a cloud community GUI that is running on a computing device, such as a laptop, a PC, a tablet, a smart phone and the like. The GUI can be a browser-based application with the ability to decode and encode the Data File 122 based on the Token 123. The cloud community GUI can be open source or a proprietary tool of platform. The Cloud Community 110 can further provide a browser-based interface to access, interact with, or otherwise manipulate the data. These and other features of the Cloud Community 110 makes it a fluid and efficient data manipulation platform that facilities entry, access, exchange and manipulation of 3-D data that is lacking today.

It will be understood that the Cloud Community 110 encompasses all of the resources necessary to carry out the processes described herein and as such can incorporate all of the servers, routers, processors, terminals, user interfaces, APIs, programs, applications, etc., needed to perform the functions described herein. It will also be understood that the various components of FIG. 1 can communicate over the Network 160, such as the Internet, and can include wireless and wired WANs, LANs, PANs, etc.

To facilitate further understanding of the overall operations of the disclosed technology, the following example provides a simplified sequence of events that can take place as part ingestion, processing, and usage of the data produced by a user of the 3D community. In this simplified example, a kiosk at an entry point logs into the 3D cloud community. The user (Sam) then arrives at the kiosk, and initiates a 3D scan. If Sam is a first time user, he can register for an account with the 3D community. If he is already a member, he can log into his account. Sam can further click through a user agreement and accept the terms and conditions for using the system. The kiosk then uploads the 3D scan data, in the appropriate format, to the 3D community. The kiosk further transfers ownership of the 3D scan data to Sam and removes its access from the data to protect Sam's privacy. Sam can then log into the 3DCC community and access the 3D data (if he so desires). For example, Sam can share all or a portion of the data with a vendor of his choice. The vendor can also log in and view Sam's shared data (along with appropriate instructions and/or entitlements) and download the data.

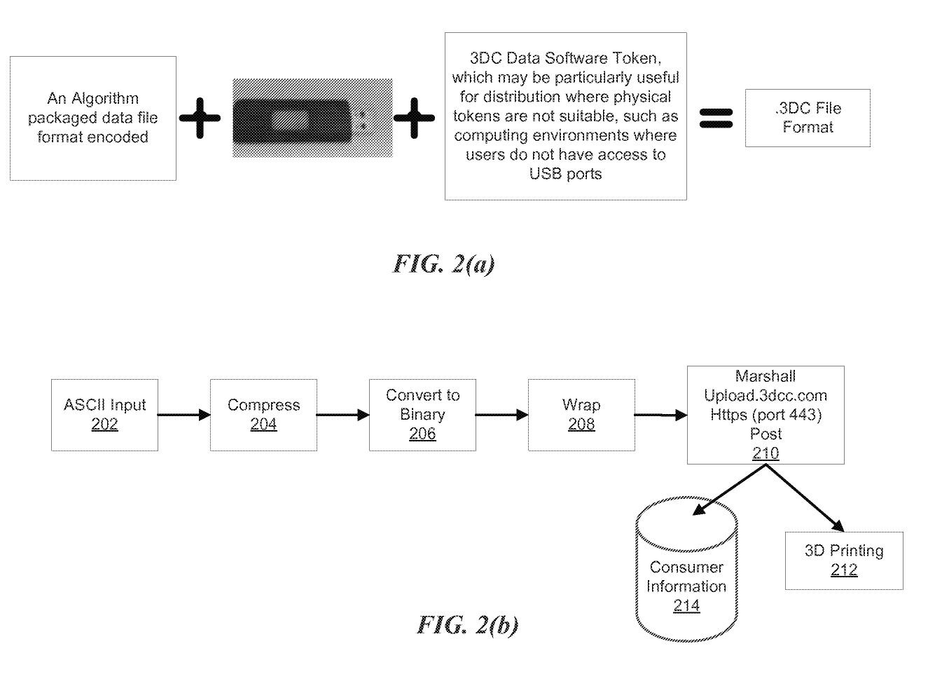

FIG. 2(a) is a simplified illustration of data that is encapsulated in a specified file format in accordance to one exemplary embodiment. The data format allows dynamic collection, management and distribution of data amongst a plurality of entities in the Cloud Community. One specific example of the file format is a .3DC file that can be generated at an entry point to the cloud community. It should be noted that the name “.3DC” is used as an example to facilitate the description of the disclosed technology. It is, however, understood that any other appropriate name may be used. In some implementations, all data entering and residing in the Cloud Community (e.g., the Data File 122) is created in, or converted to, the specified file format. As such, the specified file format standardizes data and generates a more perfect file that can be consumed and managed throughout the Cloud Community.

As illustrated in FIG. 2(a), an exemplary file format comprises an algorithm packaged data file that is encoded with cryptographic physical and/or soft token entitlements necessary to create, compress, decompress, and access the .3DC file. Soft token and hard token are cryptographic and security mechanisms that are put in place by the inventors of the disclosed system to protect data and prevent unauthorized access to the data. A soft token can be, for example, implemented as a two-factor authentication security that may be used to authorize the use of a computer or a data, and do not require the use of a specific hardware device to allow access to the files. This is in contrast to hardware tokens, where the credentials are stored on a dedicated hardware device. In some implementations, these security protocols are compliant with certain regulations (e.g., they are HIPPA-compliant). In some implementations, cryptographic techniques that use a 128-bit encryption, or a 256-bit encryption are used.

FIG. 2(b) is an exemplary flow diagram that illustrate some of the operations that can be carried out to produce and navigate data in the specified file format in one implementation. At 202, the ASCII file corresponding to the 3D data is generated. At 204, the data is compressed. At 206, the data is converted to a binary format, and at 208 the binary data is wrapped (e.g., using Python-coded algorithm). At 210, the coded data is marshalled to the 3DCC node. The data can then be stored (at 214) and/or sent for 3D printing (at 212).

The 3DC file also includes entitlements. Entitlements are assigned to a 3DC file by a user or an owner of the file that can permit the use of the file by a specific entity, for a specific duration, and for a specific purpose. For instance, returning to the recurring example of the 3D image of Sam's foot, Sam can assign one or more entitlements to the 3DC file e.g., at the kiosk, or at a later time using his computer or smart phone. Specifically, Sam can assign a first entitlement that is valid for a period of one month, and allows the generated 3DC file to be shared with a particular podiatrist, only for the purpose of designing Sam's insole. Thus, in this example, Sam's data cannot be used for, e.g., marketing purposes, or aggregated into another data base to, for example, improve the overall design process of insoles. Sam can also assign additional entitlements to his 3DC file. For example, Sam can create a second entitlement that allows Dr. Scholes to use the file to manufacture the insole.

The 3DC file also includes additional items that can include, but are not limited to, a name, social security number (SSN) that identifies the owner of data, employer identification number (EIN) that can identify the recipient of the data, medical data, and computed tomography (CT) scan. The Cloud Community can compress and decompress the .3DC data files according to the specifications or requirements of the intermediary entity, destination entity (e.g., Cloud 130, Additional System 140 in FIG. 1), or the exit point (e.g., Exit Point 150 in FIG. 1).

Data encoded in the specified file format (e.g., the 3DC file format) can be broken up into fields or groups of data. For example, one field may be a header section. Different sections of the file can provide the different types of information. The header area can, for example, include information regarding the path of data that enables movement of the file through the 3DC community. The file can also include (e.g., as part of the header section, or separate from the header) the following information: license entitlements, country of origin, unique source and destination identifiers (e.g., bar code, social security number, employer identification number), CAD file format that is preferred by a particular destination device or exit point, accepted industry standard files (e.g., ProEngineer, Mastercam, AutoCAD, Inventor, Solidworks, SolidEDGE, ALIAS, CATIA, STL flag, medical records, information regarding high and low resolution data, and other information. The header area can include information that is encoded in ASCII format. The information in the header area can also be used for tracking purposes. For example, tracking information can include a source identifier (e.g., a person's social security number) and a destination identifier (e.g., a manufacturer's employer identification number), which allows the owner of the data and a particular destination to be uniquely identified. Additionally, the tracking information can include information regarding a total number of all frames of each piece of data and the sizes of each frame. The tracking information can be used to regenerate the data, by, for example, rendering and combining the individual frames. Another feature of the .3DC file is that data can be encoded into and decoded from the .3DC file format without computer aided design (CAD) software or viewer.

The disclosed embodiments further allow the use and conversion of STereoLithography (STL) files. STL is a file format native to the stereolithography CAD software and is widely used for rapid prototyping and computer-aided manufacturing. STL files describe only the surface geometry of a three-dimensional object without any representation of color, texture or other common CAD model attributes. The STL format specifies both ASCII and binary representations, and contains polygon mesh objects. One of the advantages of the disclosed embodiments is that the algorithm that is part of the disclosed file format allows encoding and decoding of data between ASCII and mesh rebuild STL. For example, an “unwind” algorithm is applied to convert data from ASCII to STL mesh. In some implementations, data conversion (e.g., between ASCII and STL) is carried out at user premise.

The 3DC file, as part its header section or in a different section, can include information regarding low resolution and high resolution data. Such information can be used to identify and extract low and high-resolution data that is included in a data section of the file format. For example, ASCII data can be stored in the file as low resolution data while STL data can be stored as high resolution data. The low resolution data can, for example, be a version of the high resolution data that has been simplified to reduce the number of vertices for mesh features or to reduce the number of points for point cloud features. As is known in the art, point cloud files are generated by some 3-D scanning devices that measure a large number of points on an object's surface, and often output a point cloud as a data file; the point cloud represents the set of points that the device has measured. As a result of reduction of high resolution data, a simpler, smaller, and much more portable file is generated. In some implementations, the Cloud Community always retains a copy of data in a high resolution format (e.g., in STL), end users (such as the User 121 in FIG. 1) and third-party entities (such as the Additional System 140 in FIG. 1) may need or prefer to access, transfer, or otherwise handle the data in low resolution format (e.g., ASCII).

While the a user (such as the User 121 of FIG. 1) can save a data file in a low resolution format, the user can also direct the Cloud Community to provide or to give access to the data file in a low resolution format. The user can also specify or customize the resolution in which the Cloud Community is to deliver the data file. In some embodiments, the Cloud Community can automatically determine an appropriate resolution (e.g., high, low, custom) in which to deliver or to provide data (e.g., Data File 122 of FIG. 1). The Cloud Community can make its determination based on, for example, one or both of source entity or destination entity specifications, capabilities and/or requirements. For example, a particular entity may require that all files to be in a standardize format that necessitates a specific resolution.

The user can also direct the Cloud Community to provide or give access to only specific portion(s) of the data file. For example, the data file can contain 3-dimensional data (e.g., produced via scanning) of Sam's entire body. However, a particular vendor, e.g., Dr. Scholl's®, will only require data for Sam's foot to build the desired insole. Thus, instead of transferring to or giving Dr. Scholl's® access to the data file in its entirety, Sam can direct the Cloud Community (e.g., through a specific entitlement) to give Dr. Scholl's® access to only the portion of the data file containing the data relevant to Sam's foot. In some implementations, the Cloud Community can apply simplification to only select portions of a data file. For example, Sam can choose to have only the foot portion of his full body scan saved or transferred in a low resolution format. Alternately, Sam can have data of the foot portion of his full body scan transferred or delivered to Dr. Scholl's® in a vendor required resolution.

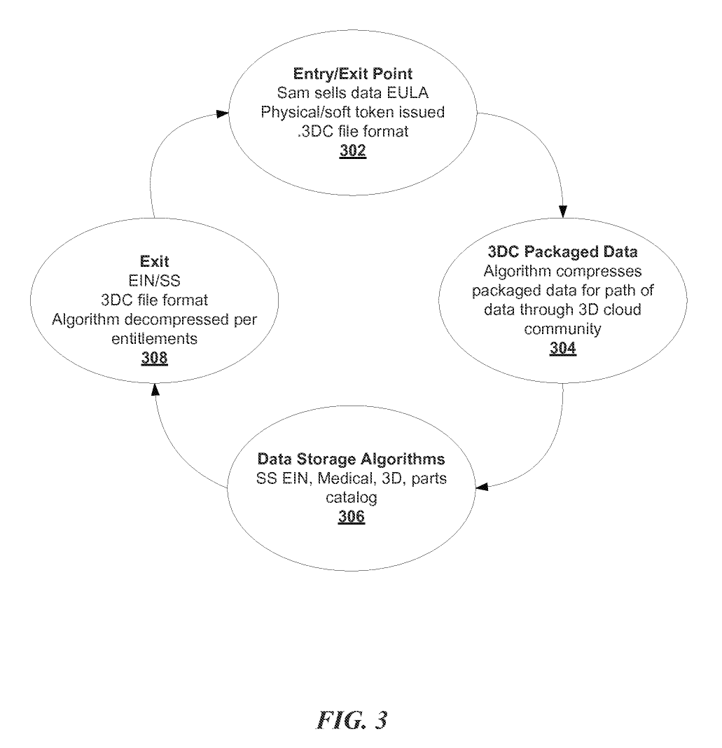

FIG. 3 is an exemplary diagram of various operations that can be carried out on by different entities or components of the cloud community to facilitate management, processing and traversal of 3-dimensional data within the cloud community. At 302, data is captured at an entry point (e.g., the Entry Point 120 of FIG. 1) and uploaded into the Cloud Community. The data can, for example, be captured in the .3DC file format. The entry point can further issue a physical and/or a virtual token that for the captured data. As one example, Sam can take a scan of his foot at an entry point and is issued a token (e.g., physical and/or virtual token). At this point, Sam and his data are said to have entered the Cloud Community.

Referring again to FIG. 3 at 304, the data file is further processed as it continues its path through the Cloud Community. The file can be processed by applying compression algorithms to the data as needed in order to be able to provide data to third party entities. Sam can also provide entitlements and request that, for example, his data file be transferred or provided to his orthopedist. Consequently, the Cloud Community (an entity therein) compresses Sam's data file so that it can be sent to Sam's orthopedist. At 306, the data file is accessed, manipulated, or otherwise interacted with. Sam's orthopedist, for instance, can add or attach Sam's electronic health records to the data file. One or more entities in the Cloud Community applies one or more appropriate data storage algorithms in order to combine, integrate, or associate the added data with the existing data file. At 308, the data file exits at an exit point (e.g., Exit Point 150 that is shown in FIG. 1). Data can exit the Cloud Community directly or indirectly. For example, Sam can directly retrieve his data file at an exit point (e.g., Exit Point 150 of FIG. 1). In general, users can print from a data file or permanently remove a data file from the Cloud Community at each exit point. Alternately, Sam can give access or permission to access his data file to a third party entity, such as an insole manufacturer like Dr. Scholl's®. Dr. Scholl's® can then print from Sam's data file, in which case Sam's data indirectly exits from the Cloud Community.

It should be noted that the 3DC community includes the necessary infrastructure (e.g., servers, storage devices, databases, computers, networks, etc.) to ensure smooth operation of the cloud community and provide management and flow control within the infrastructure. To this end, the administers, operators and/or owners of the 3DC system ensure that proper security mechanisms are installed to protect against cyber attacks, administer membership (and/or admission) to the 3DC community, to provide the proper log-in, web access, log-out, and searching capabilities, to provide various usage-related and transaction statistics (e.g., the number of bytes of storage used, the number of transactions conducted, etc.) and to ensure proper path of data through the 3DC community. In some implementations, an administer can log into the cloud by presenting administrator-specific credentials, such as a specific username and password.

In some embodiments, an entity of the 3DC community operates as a broker of data, including by collecting and transacting data from multiple users and entities. The Cloud Community can also allow individual users and entities to monetize their data. For example, users (e.g., Sam) can sell or to lease their data to other users or entities for a fee. At the same time, entities (e.g., Nike®, Dr. Scholl's®) can purchase or lease data from users and other entities. Meanwhile, entities within the Cloud Community can act as brokers by transferring or otherwise delivering data from a source entity to intermediary and destination entities.

In some implementations, an entity (e.g., a user, a vendor, a service provider, a manufacturer, etc.) can become a member of the 3DC community by paying a membership fees that allows the entity access to the 3DC features. In some implementations, a tiered membership structure allows for different levels of usage of the 3DC Community's features. For example, a basic level of membership can allow entry and storage of data while a higher level of membership may allow sharing of the stored information with other community members. In some implementations, different entities can be treated deferentially; for example, sellers may be charged a different membership fee than buyers. In some examples, a per-transaction membership fee or charge may be implemented. For example, a particular fee may be charged for storing the data, another fee may be charged for sharing of data (e.g., for research/analysis purposes), another fee for processing of data by an additional member of the 3D community (e.g., by a doctor that views and perhaps process the 3D data of a patient), another fee for sending data to a particular vender (e.g., for 3D printing purposes), another fee for generating a lead, etc. In some implementations, certain features of the 3DC community may be freely provided to all registered members.

As is evident from the description of the membership structure, the disclosed system allows different transactional and business-related implementations. For example, the disclosed technology enables an auction like (e.g., NASDAQ-like) transactional system that allows bids by buyers to be accepted by sellers to monetize one or more aspects of the 3-dimensional data that is ingested by the system. The system also allows a conventional sales of 3-dimensional data, rent or lease of the 3-dimensional data, lead generation (e.g., commissions or royalty paid when use or a sale of the 3-dimensional data takes place), free access and use to certain 3-dimensional data, and other types of transactions related to the use and sharing of 3D data.

A Cloud Community can be set up with one or more specific objectives. In one example, the Cloud Community can be a cloud for US Veterans with the intention of aggregating and distributing data that would lead to the design and manufacture of better prosthetics. Other examples of Cloud Community can be a regional cloud (e.g., a US-China cloud or an EU cloud) for ethical, just innovation and trade.

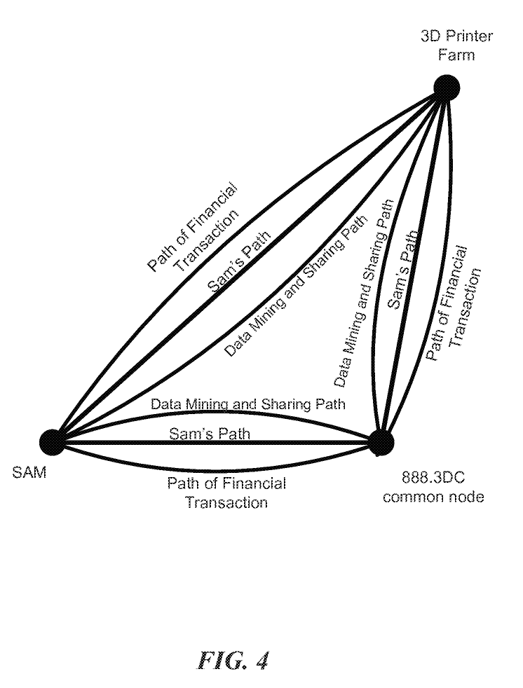

FIG. 4 illustrates an exemplary Data Path using 3 nodes of the 3-dimensional cloud community. As shown in FIG. 4, data travels between three nodes: Sam, 888.3DC Common Node, and a Printer Farm. Similar to the previously described examples in this documents, Sam represents a user that utilizes an entry point to the cloud community to, for example, submit a 3-dimensional data file associated with Sam's foot. 888.3DC is the 3-dimensional customized data file that is generated and managed in accordance with the disclosed techniques. The printer farm is coupled to an exit point and enables 3-dimensional printing of some or portions of the 888.3DC files. In one example, Sam instructs the Cloud Community to transfer or provide access to his data to the Common Node. The Common Node can be a 3DC node that can receive a data file and/or instructions from the users, vendors or other participants of the cloud community. The Common Node can further instruct the Cloud Community to transfer or to provide access to the data file to the Printer Farm. The object or the product can be printed at the Printer Farm in an appropriate material. As discussed earlier with respect to the Exit Point, one or both of the Common Node or Sam can select an appropriate printer to render the object. In FIG. 4, the path that is illustrated using straight lines between the three nodes corresponds to the path of data corresponding to the user (e.g., Sam). FIG. 4 also shows two additional paths (i.e., two elliptical paths, one outside of the straight lines and one inside of the straight lines). One of the two elliptical paths can, for example, correspond to a financial transaction path (e.g., a path of data used by a vendor of the cloud community) and the other can, for example, correspond to the path of data that is used for data mining and sharing. As was noted earlier, the disclosed technology provides an ecosystem that enables sharing and collaboration among various members of the 3D community, as well as collection and use of analytics.

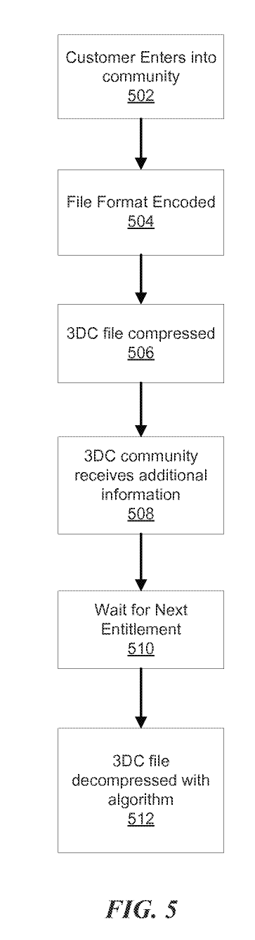

FIG. 5 illustrates a set of operations 500 that can be carried out to dynamically collect, manage, and distribute data. At 502, a person enters into the 3DC community by, for example, agreeing to a click-through agreement that sets forth the terms and conditions of the 3DC community. For example, Sam consents to or acknowledges Cloud Community's User Agreement, which can be presented as a “clickthrough” or a “clickwrap” agreement. For example, the User Agreement specifies a transfer in the ownership of 3-D data to the Cloud Community. At 504, the data provided by the person is encoded according to a specified or customized format. In some implementations, the entry point capturing the person's data generates a file containing the captured data in the customized format (e.g., .3DC format). In other implementations, if the data from the entry point is not in the customized format, the Cloud Community encodes the person's data to be in the customized format. In addition, in some embodiments, the entry point or the Cloud Community dispenses a cryptographic physical or virtual token. The token, whether physical or virtual, allows the person to access the data. For example, an Entry Point to the cloud community can give Sam a physical or a virtual token that corresponds to his data file. The token entitles Sam to the data of his foot. Sam can give (i.e., provide an entitlement) that allows access permission, transfer or otherwise conduct transactions on his data file with third-party entities by referring to or by providing the token.

Referring again to FIG. 5, at 506, the data file in the specified format is compressed. In some embodiments, the Cloud Community compresses the data files using an algorithm or technique that is appropriate for or supported by intermediary or destination entities. For example, if Sam requests that the Cloud Community transfer or otherwise provides access to his data file to his orthopedist, the Cloud Community can compress Sam's data file so that it can be transferred to or otherwise accessed by Sam's orthopedist (e.g., System 150 in FIG. 1). At 508, the Cloud Community collects data from various persons on an on-going basis (i.e., Sam or the cloud). Such data can, for example, enable a more perfect design of the insole. At 510, the Cloud Community can wait for the an entitlement (if it does not already exist) or for the next entitlement. For example, Sam may decide to use his smart phone to log onto the system and provide an additional entitlement to another podiatrist, or another insole manufacturer. In some instances, managing and distributing of data includes transferring or providing access to the data to third-party entities. At 512, the Cloud Community decompresses data using an appropriate algorithm and in accordance with specifications or requirements of the intermediary entity or destination entity (e.g., the Cloud 130 or Additional System 140 of FIG. 1), or of the exit point (e.g., the Exit Point 150 of FIG. 1).

As noted previously, entry and exit to the cloud community can be accomplished in multiple ways including direct entry and/or exit of a user to the 3DC community, brokered entry and/or exit of a user to the 3DC community, direct entry and/or exit of a vendor to the 3DC community and brokered entry and/or exit of a vendor to the cloud. Entry of a user or a broker into the 3DC community allows that party or entity to utilize services and products that are available to the 3DC community in a secure and expedited manner, as is further described below.

In a direct entry/exit scenario, the party or entity is able to directly participate in the 3DC community by presenting an offer, receiving or providing consideration (e.g., providing payment, services, etc.) and authorizing and fulfilling a particular transaction. Such an entry or exit is often contingent upon signing an end-user license agreement (EULA) that formulates the terms and conditions of uses of the 3DC community.

In a brokered entry/exit scenario, the party or entity interacts with the 3DC community through a third party entity. For example, a user (e.g., Sam) may use a third party (e.g., Apple) to indirectly enter the 3DC community. The third party may, for example, be coupled or use a particular cloud configuration (e.g., iCloud) that is coupled to the 3DC community. In this scenario, an entry point to the 3DC community can be specifically designed to accommodate the needs of the third party (e.g., Apple) to enter the 3-D cloud community. As such, the entry point can be equipped, or coupled to, specific hardware and/or software components that are designed to receive, process (if necessary) and import the data received from the third party to a format that is compatible for digestion by the 3D community. In a brokered exit scenario, the goods and services received by the user are provided through the third party (if the third party has the requisite capability for production and/or delivery of the items).

In some scenarios, a combination of direct and brokered entry/exit can be implemented. For example, a brokered entry may be accompanied by a direct exit (e.g., upon Sam's brokered entry through a third party, Sam receives an insole directly from a 3-D printer of a printer farm). Further, in some implementations, an entity may have an option between a direct or brokered entry/exit, any one or combinations of which may be selected by the user, or by one or more entities in the 3DC community, to facilitate the user's interaction with the 3DC community, or to provide an efficient use of the 3DC community resources.

An exemplary direct entry scenario can be described as follows by reference to the recurring example where Sam is attempting to obtain an insole for his shoe. First, Sam conducts a 3-D scan of his foot. This operation can be carried out at, for example, a kiosk that is set up with the necessary configuration of hardware, software and imaging devices to complete this task. In one example, a blue light camera-detector system is used to carry out this operation. For instance an HDI 120 3D Scanner from LMI Technologies that uses blue LED projection technology can be used. In another example, a laser white light detection system is used to carry out this operation. Other scanning devices and technologies (e.g., X-ray, CT scan, etc.) can be additionally or alternatively used.

Next, the data corresponding to the 3-dimensional scans are processed to produce data in a customized file format (e.g., .3DC format). Next, the user (e.g., Sam) fulfils at least part of the transaction and agrees to the terms and conditions of the 3D cloud community. The fulfillment can, for example, include providing a monetary consideration (e.g., a credit card number and authorization for payment of a particular amount). Next, Sam selects part of the data to be communicated to a particular vendor (e.g., Nike, Dr. Scholl's, etc.) or to an intermediary entity (e.g., Sharp Medical Group's podiatrist). The user (e.g., Sam) and the recipient(s) (e.g., Nike, Sharp Medical Group, etc.) can be identified through unique identifiers, such as a social security number, an employer identification number, or any other identifier that is selected by the user, or assigned by the 3D cloud community. A user may utilize a search or a directory feature of the cloud community to find the appropriate vendor, seller, service provider, or an intermediary entity.

In a direct exit scenario, Sam receives the insole when the 3D cloud community directs the portion of Sam's data (e.g., upon further modifications by the podiatrist, sampling, compression, encryption, decryption or decompression and conversion to a printer-compatible 3-D format by the cloud community components) to a printer farm at the exit point, where the insole is rendered using a suitable material at a 3-D printer.

In a brokered or indirect entry scenario, Sam enters the 3D cloud community through a vender (e.g., Apple's iCloud). In one example, the entry point to the 3D Cloud community is an Apple application running on a Apple device. Upon provision of the 3-D data, the Apple device ingests the 3-D file and provides it to the 3-D cloud community through an entry point that is dedicated to Apple. The received file is then converted to the customized format of the 3-D cloud community (e.g., .3DC file format). The remaining operations are similar to those described above in connection with direct entry to the cloud community.

Table 1 below shows the contents of a example customized 3D data file (e.g., a .3DC file in accordance with an exemplary embodiment.

| Field Name | Purpose |
|---|---|
| Version | Identify the version of the 3DC file |
| Digital Signature | Verifies authenticity of File |
| Encryption | Identifies the type of encryption used |
| | (e.g., algorithm, key length, etc.) |
| Table of Contents | Defines parameters that are implemented |
| | as part of data file and allows parsing of |
| | the remaining portions of the file |
| General Header | Stores general information about user |
| Question Header | Identifies intended vendor(s) that the data |
| | file |
| Agreement | Yes/No field identifying whether or not |
| | user has agreed to a Click-Through |
| | agreement |
| Object Header | Identifies whether the 3D scan data |
| | corresponds to a living, or non-living |
| | object |
| Device Type | Identifies device type used to collect 3-D |
| | data |
| Color Table | Identifies color coding of the image (e.g., |
| | RGB, etc.) |
| Scan Or Load Object | Identifies whether 3D data was scanned |
| | or uploaded as e.g., a preexisting file |
| Scan Point Count | Defines maximum point resolution |
| Image Size | Identifies the size of raw 3-D data (e.g., |
| | in Bytes) |
| End user recall view | An entitlement-based field that indicated |
| decimation | amount of decimation to be used for a |
| | particular type of viewing (e.g., entity X |
| | may use 3D data at first resolution, while |
| | entity Y 3D data at a second resolution) |
| Compression | Identifies the type of compression that to |
| | be used for, e.g., uploading data to the |
| | cloud |
| Usage of Scan Data | An entitlement-based field that indicates |
| | permitted usage of data; |
| Cloud Compression | Identifies the type of compression used |
| | after data enters cloud community |

One example procedure for generating the customized file format is as follows. In this example, a kiosk is used generate the 3D data. Such a kiosk includes various scanning hardware and the associated software to allow generation of raw 3D data. At the kiosk, the user creates an ASSET_ID (which can include, for example, a social security number, an employee identification number, or can be random number) using a personal PIN. The ASSET_ID can be used as a way of identifying the data file that was just generated. The entry point that incorporates appropriate software and/or firmware capabilities, receives such data, further processes the data. Such processing can include compressing the data, encrypting the data, converting into binary, adding appropriate headers, and communicating the processed data to an entity within the cloud, such as a server. In one example, the data is sent to the server as an HTTPS post request on port 443 of the server. The server's DNS is notified of a pending upload. In some implementations, the customized data file includes a field for activating an algorithm that makes the data conversion. Such an algorithm may be incorporated into the data file itself. Alternatively, or additionally, at least a portion of the algorithm may be activated in subsequent operations at, for example, a device that receives the data and is triggered to execute the algorithm.

The custom files that are produced in accordance with the disclose techniques can be HIPPA Compliant. In particular, all such data can be kept in encrypted format (using a 128-bit key or longer) and only cloud vendors that can sign Business Associate Agreement (BAA), and can take precautions to not expose any personal health information (PHI) to unauthorized personal, can participate in handling of such data. In one example, Amazon Web Services EC2 and S3 are used, both of which are HIPPA-Compliant services. In particular, S3 supports encryption of data at rest and using of HTTPS secure protocol to upload and download the data. In some implementations, temporary URLs are used for all PHI assets hence no user can access any secure assets without proper authentication. Additionally, all keys for the data will be kept in server memory and only limited individuals can have server access.

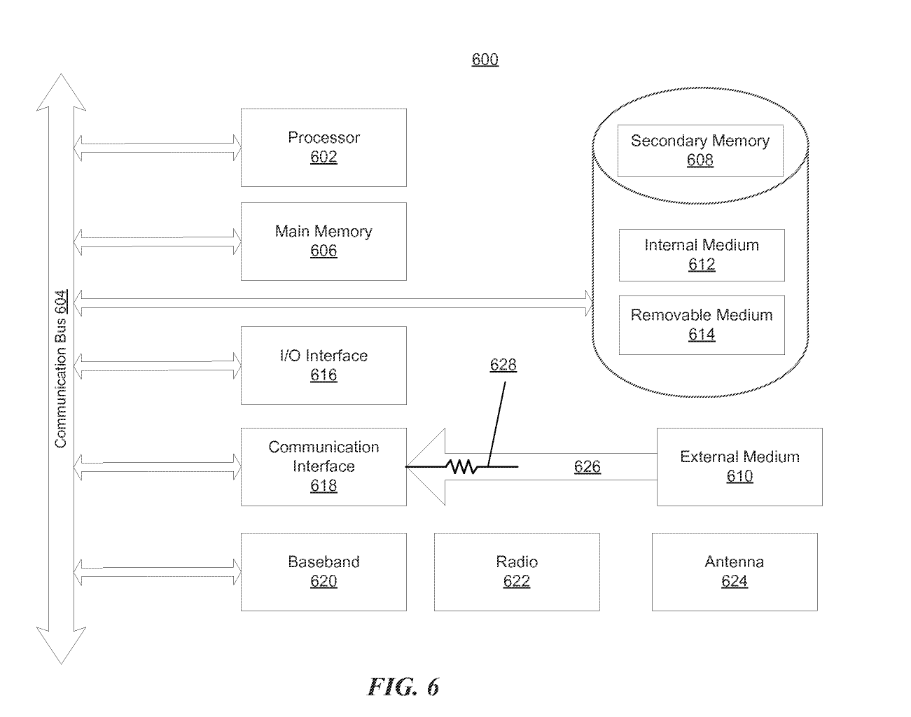

FIG. 6 is a block diagram illustrating an embodiment of a wired or wireless System 600 that may be used in connection with various embodiments described herein. For example, System 600 may be used in implementations of the Cloud Community, as previously described with respect to FIG. 1. For example, System 600 can be implemented as part an entry point, exit point, intermediary point or other nodes and entities in the cloud community. System 600 can be a conventional personal computer, computer server, personal digital assistant, smart phone, tablet computer, or any other processor enabled device that is capable of wired or wireless data communication. Other computer systems and/or architectures may be also used, as will be clear to those skilled in the art.

System 600 can include one or more processors, such as processor 602. Additional processors may be provided, such as an auxiliary processor to manage input/output, an auxiliary processor to perform floating point mathematical operations, a special-purpose microprocessor having an architecture suitable for fast execution of signal processing algorithms (e.g., digital signal processor), a slave processor subordinate to the main processing system (e.g., back-end processor), an additional microprocessor or controller for dual or multiple processor systems, or a coprocessor. Such auxiliary processors may be discrete processors or may be integrated with the processor 602. The processor 602 can be connected to a communication bus 604. The communication bus 604 may include a data channel for facilitating information transfer between storage and other peripheral components of System 600. The communication bus 604 further may provide a set of signals used for communication with the processor 602, including a data bus, address bus, and control bus (not shown). The communication bus 604 may comprise any standard or non-standard bus architecture such as, for example, bus architectures compliant with industry standard architecture (“ISA”), extended industry standard architecture (“EISA”), Micro Channel Architecture (“MCA”), peripheral component interconnect (“PCI”) local bus, or standards promulgated by the Institute of Electrical and Electronics Engineers (“IEEE”) including IEEE 488 general-purpose interface bus (“GPIB”), IEEE 696/S-100, and the like.

System 600 can include a main memory 606 and may also include a secondary memory 608. The main memory 606 provides storage of instructions and data for programs executing on the processor 602. The main memory 606 is typically semiconductor-based memory such as dynamic random access memory (“DRAM”) and/or static random access memory (“SRAM”). Other semiconductor-based memory types include, for example, synchronous dynamic random access memory (“SDRAM”), Rambus dynamic random access memory (“RDRAM”), ferroelectric random access memory (“PRAM”), and the like, including read only memory (“ROM”). The secondary memory 608 may optionally include an internal memory 612 and/or a removable medium 614, for example a floppy disk drive, a magnetic tape drive, a compact disc (“CD”) drive, a digital versatile disc (“DVD”) drive, etc. The removable medium 614 is read from and/or written to in a well-known manner. Removable storage medium 614 may be, for example, a floppy disk, magnetic tape, CD, DVD, SD card, etc. The removable storage medium 614 is one example of a non-transitory computer readable medium having stored thereon computer executable code (i.e., software) and/or data. The computer software or data stored on the removable storage medium 614 is read into System 600 for execution by the processor 602.

In some embodiments, secondary memory 608 may include other similar means for allowing computer programs or other data or instructions to be loaded into System 600. Such means may include, for example, an external storage medium 610 and an interface 608. Examples of external storage medium 610 may include an external hard disk drive or an external optical drive, or and external magneto-optical drive. In some embodiments, external storage medium 610 can comprise one or more physical tokens dispensed by the Cloud Community. In some embodiments, external storage medium 610 can comprise a database storing one or more virtual tokens dispensed by Cloud Community 110.

Other examples of secondary memory 608 may include semiconductor-based memory such as programmable read-only memory (“PROM”), erasable programmable read-only memory (“EPROM”), electrically erasable read-only memory (“EEPROM”), or flash memory (block oriented memory similar to EEPROM). Also included are any other removable storage media 614 and communication interface 618, which allow software and data to be transferred from an external medium 610 to System 600.

System 600 may also include an input/output (“I/O”) interface 616. The I/O interface 616 facilitates input from and output to external devices. For example the I/O interface 616 may receive input from a keyboard or mouse and may provide output to a display. The I/O interface 616 is capable of facilitating input from and output to various alternative types of human interface and machine interface devices alike. System 600 may also include a communication interface 618. The communication interface 618 allows software and data to be transferred between System 600 and external devices (e.g. printers), networks, or information sources. For example, computer software or executable code may be transferred to System 600 from a network server via communication interface 618. Examples of communication interface 618 include a modem, a network interface card (“NIC”), a wireless data card, a communications port, a PCMCIA slot and card, an infrared interface, and an IEEE 1394 fire-wire, just to name a few. Communication interface 618 can implement industry promulgated protocol standards, such as Ethernet IEEE 802 standards, Fiber Channel, digital subscriber line (“DSL”), asynchronous digital subscriber line (“ADSL”), frame relay, asynchronous transfer mode (“ATM”), integrated digital services network (“ISDN”), personal communications services (“PCS”), transmission control protocol/Internet protocol (“TCP/IP”), serial line Internet protocol/point to point protocol (“SLIP/PPP”), and so on, but may also implement customized or non-standard interface protocols as well.

Software and data transferred via communication interface 618 are generally in the form of electrical communication signals 628. These signals 628 can be provided to communication interface 618 via a communication channel 626. The communication channel 626 can be a wired or wireless network, or any variety of other communication links. Communication channel 626 carries signals 628 and can be implemented using a variety of wired or wireless communication means including wire or cable, fiber optics, conventional phone line, cellular phone link, wireless data communication link, radio frequency (“RF”) link, or infrared link, just to name a few.

Computer executable code (i.e., computer programs or software) is stored in the main memory 606 and/or the secondary memory 608. Computer programs can also be received via communication interface 618 and stored in the main memory 606 and/or the secondary memory 608. Such computer programs, when executed, enable System 600 to perform the various functions of the disclosed embodiments invention as previously described. In this description, the term “computer readable medium” is used to refer to any non-transitory computer readable storage media used to provide computer executable code (e.g., software and computer programs) to System 600. Examples of these media include main memory 606, secondary memory 608 (including internal memory 612, removable medium 614, and external storage medium 610), and any peripheral device communicatively coupled with communication interface 618 (including a network information server or other network device). These non-transitory computer readable mediums are means for providing executable code, programming instructions, and software to System 600.

In an embodiment that is implemented using software, the software may be stored on a computer readable medium and loaded into System 600 by way of removable medium 614, I/O interface 616, or communication interface 618. In such an embodiment, the software can be loaded into System 600 in the form of electrical communication signals 628. The software, when executed by the processor 602, preferably causes the processor 602 to perform the inventive features and functions previously described herein.

System 600 also includes optional wireless communication components that facilitate wireless communication over a voice and over a data network. The wireless communication components comprise an antenna system 624, a radio system 622 and a baseband system 620. In System 600, radio frequency (“RF”) signals are transmitted and received over the air by the antenna system 624 under the management of the radio system 622. The antenna system 624 may comprise one or more antennae and one or more multiplexors (not shown) that perform a switching function to provide the antenna system 624 with transmit and receive signal paths. In the receive path, received RF signals can be coupled from a multiplexor to a low noise amplifier (not shown) that amplifies the received RF signal and sends the amplified signal to the radio system 622.

In some embodiments, the radio system 622 may comprise one or more radios that are configured to communicate over various frequencies. In some embodiments, the radio system 622 may combine a demodulator (not shown) and modulator (not shown) in one integrated circuit (“IC”). The demodulator and modulator can also be separate components. In the incoming path, the demodulator strips away the RF carrier signal leaving a baseband receive audio signal, which is sent from the radio system 622 to the baseband system 620. If the received signal contains audio information, then baseband system 620 decodes the signal and converts it to an analog signal. Then the signal is amplified and sent to a speaker. The baseband system 620 also receives analog audio signals from a microphone. These analog audio signals are converted to digital signals and encoded by the baseband system 620. The baseband system 620 also codes the digital signals for transmission and generates a baseband transmit audio signal that is routed to the modulator portion of the radio system 622. The modulator mixes the baseband transmit audio signal with an RF carrier signal generating an RF transmit signal that is routed to the antenna system and may pass through a power amplifier (not shown). The power amplifier amplifies the RF transmit signal and routes it to the antenna system 624 where the signal is switched to the antenna port for transmission. The baseband system 620 is also communicatively coupled with the processor 602. The central processing unit 602 has access to data storage areas 606 and 608.

The central processing unit 602 can be configured to execute instructions (i.e., computer programs or software) that can be stored in the memory 606 or the secondary memory 608. Computer programs can also be received from the baseband processor 620 and stored in the data storage area 602 or in secondary memory 608, or executed upon receipt. Such computer programs, when executed, enable System 600 to perform the various functions that are described in this patent document. For example, data storage areas 606 may include various software modules (not shown) that are executable by processor 602.

Various embodiments may also be implemented primarily in hardware using, for example, components such as application specific integrated circuits (“ASICs”), or field programmable gate arrays (“FPGAs”). Implementation of a hardware state machine capable of performing the functions described herein will also be apparent to those skilled in the relevant art. Various embodiments may also be implemented using a combination of both hardware and software.

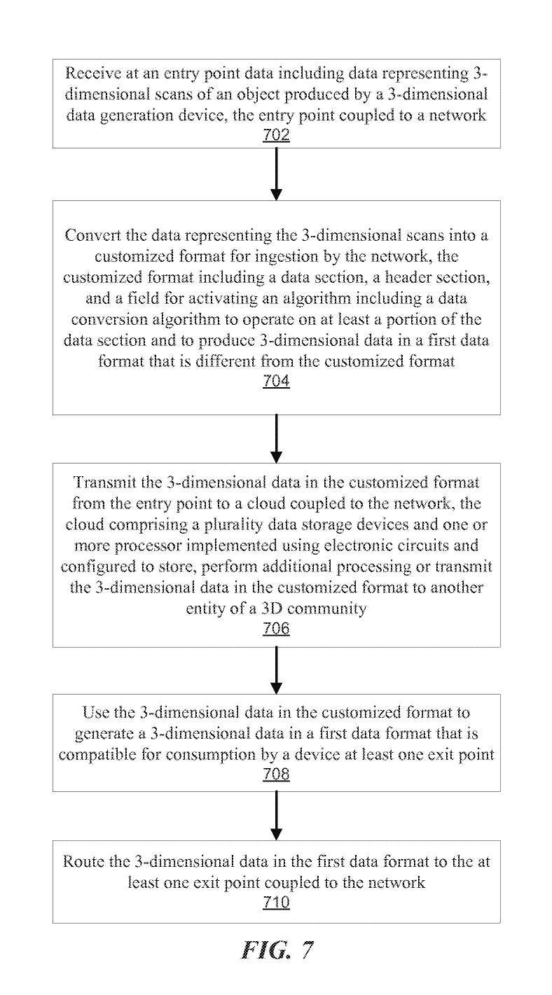

FIG. 7 illustrates a set of exemplary operations for managing 3-dimensional data in accordance with the disclosed technology. At 702, data including data representing 3-dimensional scans of an object produced by a 3-dimensional data generation device is received at an entry point, The entry point is coupled to a network. At 704, the data representing the 3-dimensional scans is converted into a customized format for ingestion by the network. The customized format includes a data section, a header section, and a field for activating an algorithm including a data conversion algorithm to operate on at least a portion of the data section and to produce 3-dimensional data in a first data format that is different from the customized format. In some implementations, the data conversion algorithm can constitute a section of the customized data format. At 706, the 3-dimensional data in the customized format is transmitted from the entry point to a cloud coupled to the network, the cloud comprising a plurality data storage devices and one or more processor implemented using electronic circuits and configured to store, perform additional processing or transmit the 3-dimensional data in the customized format to another entity of a 3D community. At 708, using the 3-dimensional data in the customized format, a 3-dimensional data in a first data format is generated that is compatible for consumption by a device at least one exit point, and at 710, the 3-dimensional data in the first data format is routed to the at least one exit point coupled to the network.

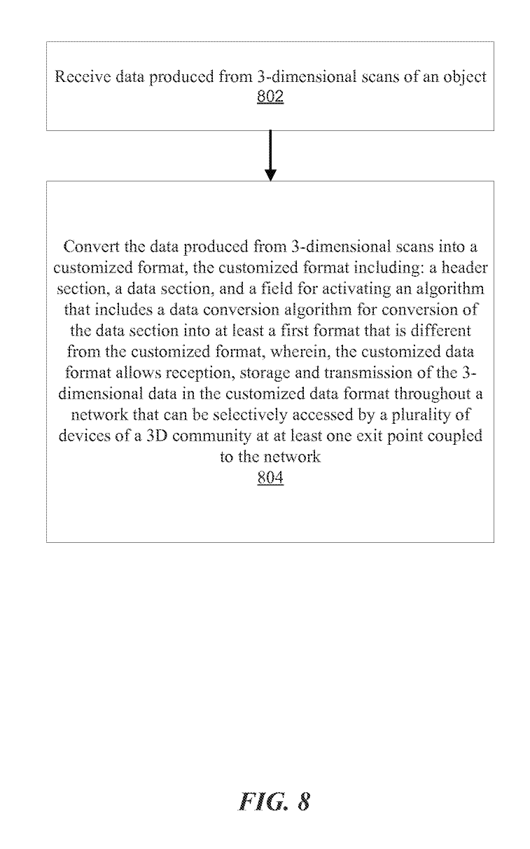

FIG. 8 illustrates a set of exemplary operations for producing a customized 3-dimensional data for ingestion by the 3D community in accordance with the disclosed technology. At 802, data produced from 3-dimensional scans of an object is received. At 804, the data produced from 3-dimensional scans is converted into a customized format. The customized format includes a header section, a data section, and a field for activating an algorithm that includes a data conversion algorithm for conversion of the data section into at least a first format that is different from the customized format. The customized data format allows reception, storage and transmission of the 3-dimensional data in the customized data format throughout a network that can be selectively accessed by a plurality of devices of a 3D community at at least one exit point coupled to the network.

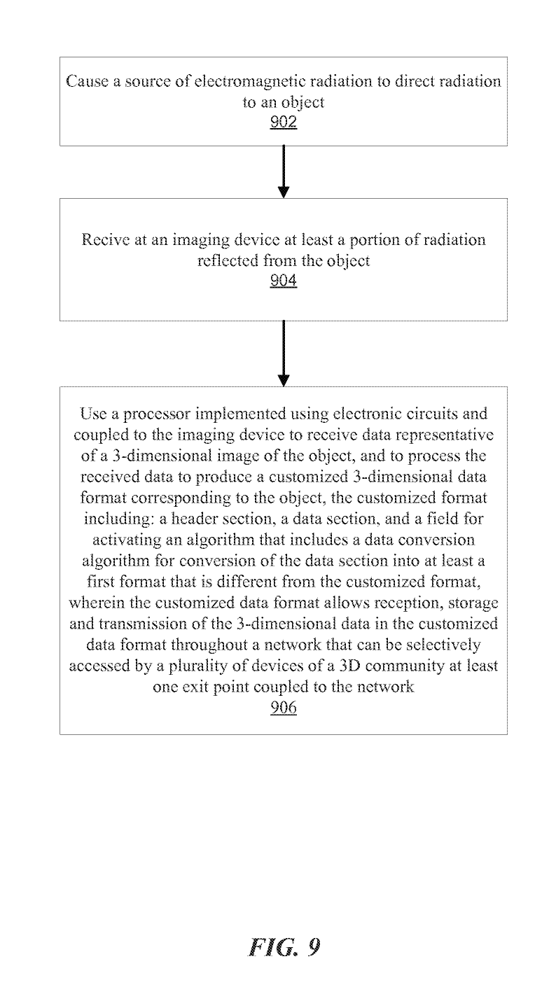

FIG. 9 illustrates a set of exemplary operations for producing a customized 3-dimensional data by an entry point of a 3D community in accordance with the disclosed technology. The operations at 902 includes causing a source of electromagnetic radiation is to direct radiation to an object. At 904, at least a portion of radiation reflected from the object is received at an imaging device. At 906, using a processor implemented using electronic circuits and coupled to the imaging device, data representative of a 3-dimensional image of the object is received and processed to produce a customized 3-dimensional data format corresponding to the object, the customized format including a header section, a data section, and a field for activating an algorithm that includes a data conversion algorithm for conversion of the data section into at least a first format that is different from the customized format. The customized data format allows reception, storage and transmission of the 3-dimensional data in the customized data format throughout a network that can be selectively accessed by a plurality of devices of a 3D community at least one exit point coupled to the network.

Furthermore, those of skill in the art will appreciate that the various illustrative logical blocks, modules, circuits, and method steps described in connection with the above described figures and the embodiments disclosed herein can often be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a module, block, circuit or step is for ease of description. Specific functions or steps can be moved from one module, block or circuit to another without departing from the invention.

Moreover, the various illustrative logical blocks, modules, and methods described in connection with the embodiments disclosed herein can be implemented or performed with a general purpose processor, a digital signal processor (“DSP”), an ASIC, FPGA or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

Additionally, the steps of a method or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium including a network storage medium. An exemplary storage medium can be coupled to the processor such the processor can read information from, and write information to, the storage medium. In the alternative, the storage medium can be integral to the processor. The processor and the storage medium can also reside in an ASIC.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent specific implementations of the disclosed technology and are therefore representative of the subject matter which is broadly contemplated by the present invention. It is further understood that the scope of the present invention fully encompasses other embodiments that may become obvious to those skilled in the art and that the scope of the present invention is accordingly not limited. The features of the embodiments described herein may be combined in all possible combinations of methods, apparatus, modules, systems, and computer program products.

1. A system for managing 3-dimensional data, comprising:
a cloud comprising a plurality of data storage devices and one or more processors coupled to a network to receive, store and transmit data including 3-dimensional data;
an entry point coupled to the network, the entry point further coupled to a 3-dimensional data generation device, the 3-dimensional data generation device to receive data produced from 3-dimensional scans of an object and to convert the data produced from 3-dimensional scans into a customized format for ingestion by the network, the customized format including a data section, a header section, and a field for activating an algorithm including a data conversion algorithm to operate on at least a portion of the data section and to produce 3-dimensional data in a first data format that is different from the customized format; and
at least one exit point coupled to the network, the at least one exit point to receive the 3-dimensional data routed by the network in the customized format, and to produce the 3-dimensional data in at least the first data format that is compatible for consumption by a device at the least one exit point.

2. The system of claim 1, wherein the one or more processors process at least a portion of the header section to route the 3-dimensional data in the customized format to the at least one exit point.

3. The system of claim 2, wherein the at least the portion of data identifies a path of data to be traversed by the 3-dimensional data before reaching an identified entity at the at least one exit point.

4. The system of claim 1, wherein the cloud is coupled to a 3D community comprising a plurality of 3-dimensional vendors, product manufacturers, sellers, buyers, brokers or professional service providers.

5. The system of claim 4, wherein one or more entities within the 3D community operate as a broker of 3-dimensional user data to receive the 3-dimensional data and to authorize transfer of the received 3-dimensional data to a recipient within the cloud community.

6. The system of claim 5, wherein the network is coupled to a second network associated with the one or more entities to allow reception of the 3-dimensional data from the second network into the network.

7. The system of claim 4, wherein the entry point enables a user to upload 3-dimensional data onto the cloud and to provide an entitlement associated with the uploaded 3-dimensional data, wherein the entitlement includes an authorization for a particular entity of the 3D community to use the uploaded 3-dimensional data for a particular purpose and for a particular period of time.

8. The system of claim 7, wherein the entitlement specifies one of a sale or a lease of the 3-dimensional data.

9. The system of claim 7, wherein the entitlement authorizes data mining operations for research, analysis or collaboration purposes.

10. The system of claim 7, further including an additional node configured to allow the user to log in as a member of the 3D community and to specify the entitlement subsequent to uploading of the 3-dimensional data.

11. The system of claim 4, wherein the 3D Community is operated by a 3D entity that enables aggregation and distribution of 3-dimensional data corresponding to anatomical body parts for facilitating design or manufacture of prosthetics.

12. The system of claim 1, further comprising an additional entity coupled to both the entry point and to the exit point, the additional entity to:
(a) receive at least one portion of the 3-dimensional data in the customized format,
(b) access the at least one portion of the 3-dimensional data in a format that is compatible with a device at the additional entity, and
(c) instruct the network to provide the at least one portion, or segments thereof, in the customized format to the at least one exit point.

13. The system of claim 12, wherein the device at the additional entity includes a processor comprising electronic circuitry to execute the algorithm to convert data section of the at least one portion of the 3-dimensional data into the compatible format.

14. The system of claim 12, wherein the processor further manipulates the at least one portion of the 3-dimensional data to generate a modified 3-dimensional data file.

15. The system of claim 12, wherein the additional entity is controlled by a third party entity different from entities that control the entry point and the exit point.

16. The system of claim 1, wherein at least some components of the entry point reside within the network, and the conversion of the data produced from 3-dimensional scans into the customized format is carried out by components of the entry point that reside within the network.

17. The system of claim 1, wherein at least some components of the entry point reside outside of the network, and the conversion of the data produced from 3-dimensional scans into the customized format is carried out by components of the entry point that reside outside of the network.

18. The system of claim 1, wherein the customized data format further includes an asset identification that uniquely identifies the 3-dimensional data.

19. A computer program product, embodied on one or more non-transitory computer readable medium, comprising:
program code for operating a cloud comprising a plurality of data storage devices and one or more processors coupled to a network to receive data including 3-dimensional data from a first entity that is part of a 3D community and is coupled to the network, to process or to store the received 3-dimensional data, and to transmit the 3-dimensional data or the processed 3-dimensional data to a second entity that is part of the 3-dimensional community;
program code for operating an entry point coupled to the network, the entry point further coupled to a 3-dimensional data generation device, the program code to receive data produced from 3-dimensional scans of an object by the 3-dimensional data generation device and to convert the data produced from 3-dimensional scans into a customized format for ingestion by the network, the customized format including a data section, a header section, and a field for activating an algorithm including a data conversion algorithm to operate on at least a portion of the data section and to produce 3-dimensional data in a first data format that is different from the customized format; and
program code for operating at least one exit point coupled to the network, the program code to receive the 3-dimensional data routed by the network in the customized format, and to produce the 3-dimensional data in at least the first data format that is compatible for consumption by a device at the least one exit point.

20-36. (canceled)

37. A method for managing 3-dimensional data, comprising:
receiving at an entry point data including data representing 3-dimensional scans of an object produced by a 3-dimensional data generation device, the entry point coupled to a network;
converting the data representing the 3-dimensional scans into a customized format for ingestion by the network, the customized format including a data section, a header section, and a field for activating an algorithm including a data conversion algorithm to operate on at least a portion of the data section and to produce 3-dimensional data in a first data format that is different from the customized format;
transmitting the 3-dimensional data in the customized format from the entry point to a cloud coupled to the network, the cloud comprising a plurality data storage devices and one or more processors implemented using electronic circuits and configured to store, perform additional processing or transmit the 3-dimensional data in the customized format to another entity of a 3D community;
using the 3-dimensional data in the customized format to generate a 3-dimensional data in a first data format that is compatible for consumption by a device at least one exit point; and
routing the 3-dimensional data in the first data format to the at least one exit point coupled to the network.

38-54. (canceled)
